(19) United States
(12) Patent Application Publication
(10) Pub. No.: US 2026/0100561 A1
(43) Pub. Date: Apr. 9, 2026

(54) ELECTRICAL JUNCTION BOX

(71) Applicants: Yazaki Corporation, Tokyo (JP); Toyota Jidosha Kabushiki Kaisha, Toyota-shi (JP)

(72) Inventors: Naoki Sakaguchi, Shizuoka (JP); Kazuki Kobayashi, Shizuoka (JP); Yoshikazu Ezuka, Shizuoka (JP); Shogo Tomihira, Nisshin-shi (JP)

(73) Assignees: Yazaki Corporation, Tokyo (JP); Toyota Jidosha Kabushiki Kaisha, Toyota-shi (JP)

(21) Appl. No.: 19/350,365

(22) Filed: Oct. 6, 2025

(30) Foreign Application Priority Data
Oct. 9, 2024 (JP) 2024-176843

(51) Int. Cl. H02G 3/08; H02G 5/06

(52) U.S. Cl. CPC H02G 3/081; H02G 5/06

(57) ABSTRACT

An object is to provide an electrical junction box in which the mounted component can be properly replaced. An electrical junction box includes a housing that includes a bus bar connection part to which a bus bar unit is connected, and a mounted component to which power is supplied from the bus bar unit via the bus bar connection part; a cover that at least covers a conductor part of the mounted component in an openable and closable manner; and a hinge that connects the cover to the housing in a rotatable manner between a close position and an open position.

### CROSS-REFERENCE TO RELATED APPLICATION(S)

The present application claims priority to and incorporates by reference the entire contents of Japanese Patent Application No. 2024-176843 filed in Japan on Oct. 9, 2024.

### BACKGROUND OF THE INVENTION

### 1. Field of the Invention

The present invention relates to an electrical junction box.

### 2. Description of the Related Art

Conventionally, for example, Japanese Patent Application Laid-open No. 2024-082354 discloses a technique relating to an electrical junction box.

Japanese Patent Application Laid-open No. 2024-082354 discloses an electrical junction box that includes a housing including a mounted component, a cover that covers the mounted component in an openable and closable manner, and a hinge that connects the cover to the housing in a rotatable manner between a close position and an open position.

In the electrical junction box disclosed in Japanese Patent Application Laid-open No. 2024-082354 described above, for example, the cover at least covers a conductor part of the mounted component in an openable and closable manner. However, there is room for further improvement in terms of properly replacing the mounted component.

### SUMMARY OF THE INVENTION

The present invention has been made in view of the above circumstances, and an object of the present invention is to provide an electrical junction box in which the mounted component can be properly replaced.

In order to achieve the above mentioned object, an electrical junction box according to one aspect of the present invention includes a housing that includes a bus bar connection part to which a bus bar unit is connected, and a mounted component to which power is supplied from the bus bar unit via the bus bar connection part; a cover that covers at least a conductor part of the mounted component in an openable and closable manner; and a hinge that connects the cover to the housing in a rotatable manner between a close position and an open position, wherein the cover includes an interference part that allows a connection between the bus bar connection part and the bus bar unit while the cover is located at the close position, and that does not allow a connection between the bus bar connection part and the bus bar unit while the cover is located at the open position.

### BRIEF DESCRIPTION OF THE DRAWINGS

FIG. 1 is an exemplary perspective view of an electrical junction box according to an embodiment.

FIG. 2 is an exemplary exploded perspective view of the electrical junction box according to the embodiment.

FIG. 3 is an exemplary perspective view of the cover of the electrical junction box according to the embodiment.

FIG. 4 is an exemplary plan view of the electrical junction box according to the embodiment, while the cover is located at a close position.

FIG. 5 is an exemplary plan view of the electrical junction box according to the embodiment, while the cover is located at an open position.

FIG. 6 is an exemplary sectional view of the electrical junction box according to the embodiment, while the cover is located at an open position.

FIG. 7 is an exemplary sectional view of the electrical junction box according to the embodiment, while the cover is located at a close position and before a bus bar unit is assembled.

FIG. 8 is an exemplary sectional view of the electrical junction box according to the embodiment, while the cover is located at a close position and after the bus bar unit is assembled.

### DETAILED DESCRIPTION OF THE PREFERRED EMBODIMENTS

Hereinafter, an embodiment according to the present invention will be described in detail with reference to the drawings. However, the invention is not limited to the following embodiment. Moreover, the components in the following embodiment include those that can be easily replaced by those skilled in the art, or those that are substantially the same.

In the present specification, ordinal numbers are used only to distinguish components, members, parts, positions, directions, and the like, and are not intended to indicate order or priority.

### EMBODIMENT

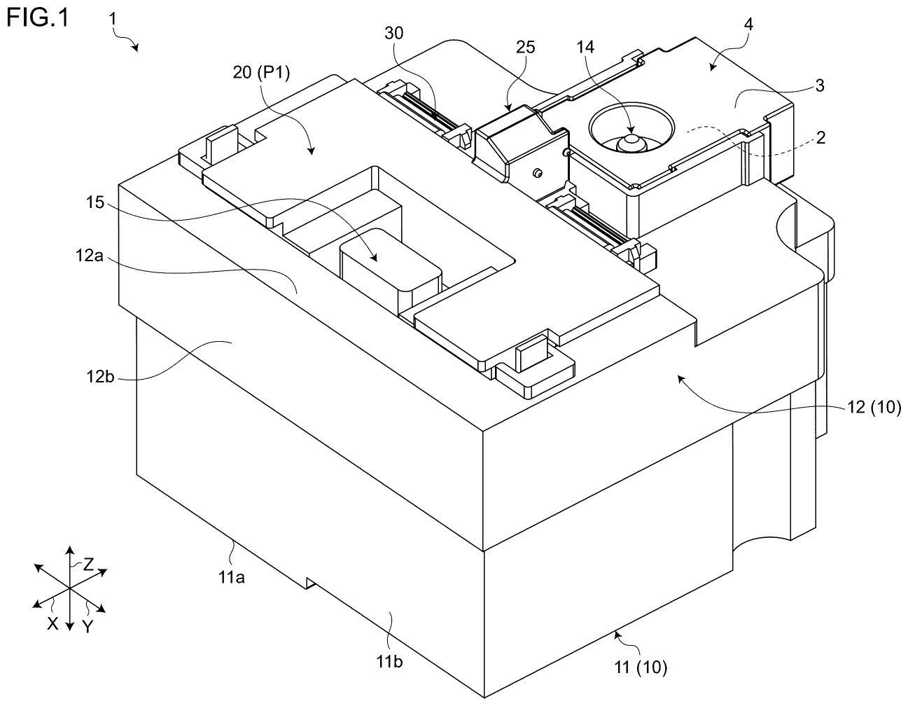

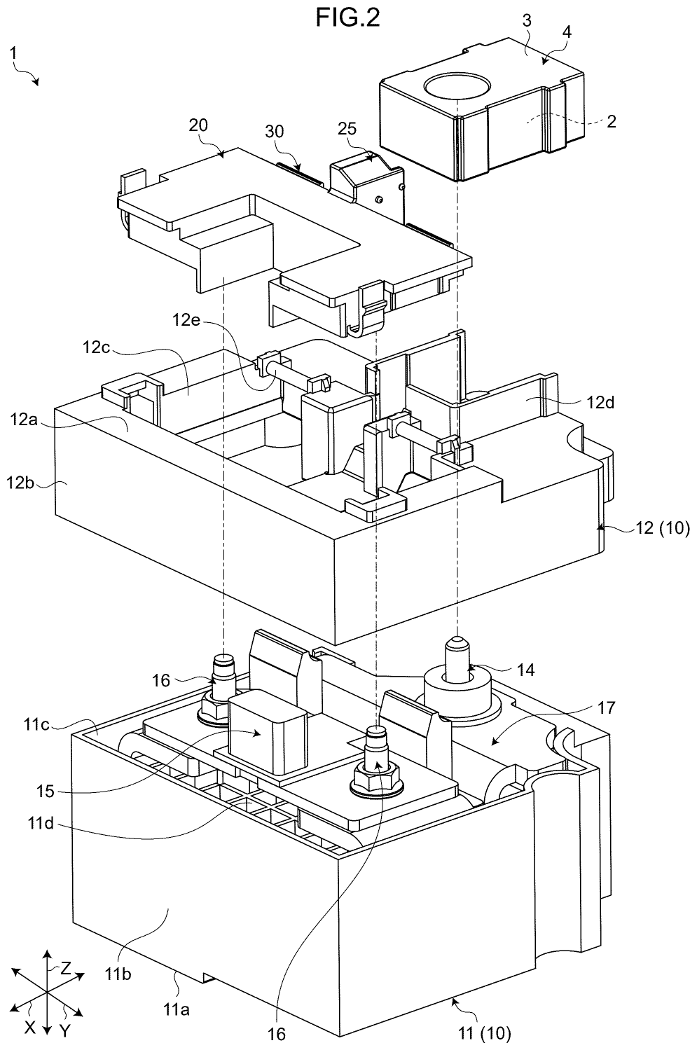

FIG. 1 is a perspective view of an electrical junction box 1 according to an embodiment. The electrical junction box 1 of the present embodiment illustrated in FIG. 1 is mounted on a vehicle such as an automobile, and for example, includes a housing 10, a cover 20, and a hinge 30. The housing 10 includes a bus bar connection part 14 to which a bus bar unit 4 is connected, and a mounted component 15 to which power is supplied from the bus bar unit 4 via the bus bar connection part 14. The cover 20 at least covers a conductor part 16 (see FIG. 2) of the mounted component 15 in an openable and closable manner.

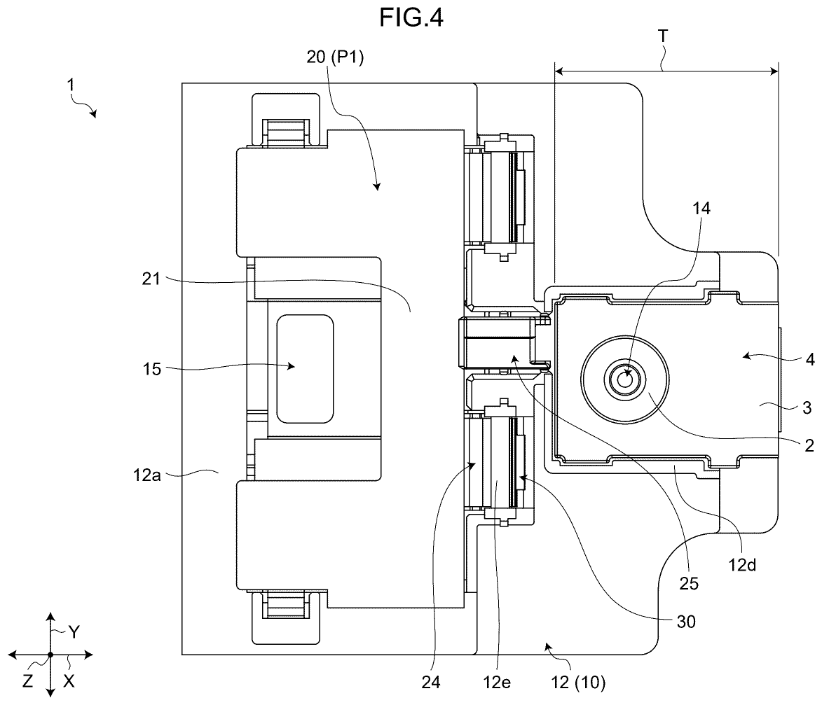

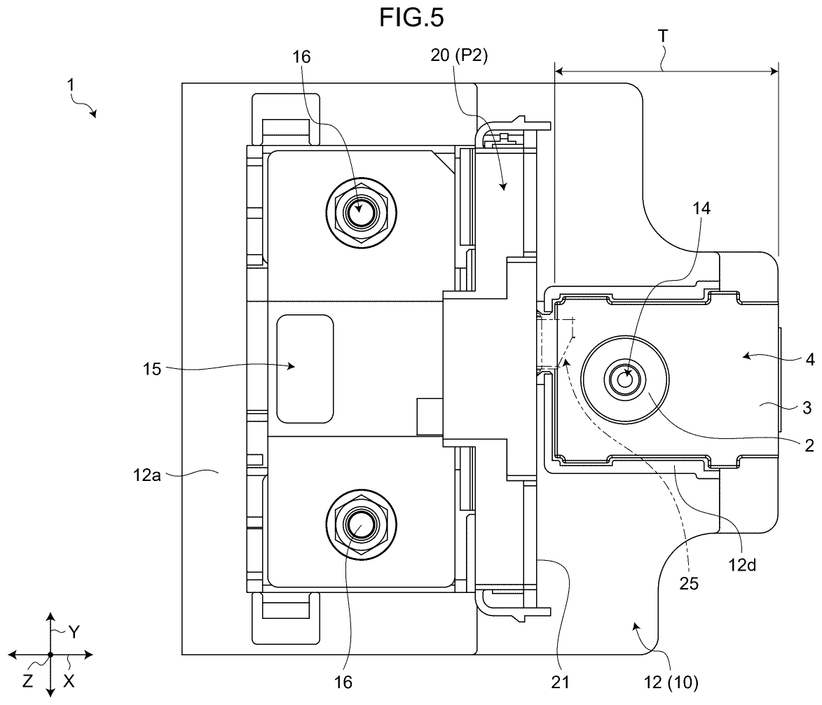

The hinge 30 connects the cover 20 to the housing 10 in a rotatable manner between a close position P1 (see FIGS. 1 and 4) and an open position P2 (see FIG. 5). In addition to the above, the electrical junction box 1 may also include various other components such as a fixture and a connector.

In the following description, among a first direction, a second direction, and a third direction intersecting one another, the first direction is referred to as an “extending direction X”, the second direction is referred to as a “width direction Y”, and the third direction is referred to as a “height direction Z”. In this example, the extending direction X, the width direction Y, and the height direction Z are substantially orthogonal to each other. The extending direction X typically align with the depth direction (front-back direction) of the electrical junction box 1, the extending direction of the bus bar unit 4, or the like. The width direction Y typically aligns with the width direction (left-right direction) of the electrical junction box 1, the width direction of the bus bar unit 4, or the like. The height direction Z typically aligns with the height direction (up-down direction) of the electrical junction box 1, the height direction of the bus bar unit 4, or the like. Moreover, unless otherwise specified, each direction used in the following description is described as a direction while the electrical junction box 1 is mounted on a vehicle.

FIG. 2 is an exploded perspective view of the electrical junction box 1. As illustrated in FIG. 2, for example, the housing 10 includes a lower case 11 and an upper case 12 that are made of an insulating resin material or the like. The upper case 12 is mounted on the lower case 11, in a state that the upper case 12 is stacked on one end side (upper side) of the lower case 11 in the height direction Z. With this configuration, by assembling the lower case 11 and the upper case 12, the housing 10 is formed in a hollow box shape as a whole. In the housing 10, the interior space part partitioned by the lower case 11 and the upper case 12 functions as a storage space part 11c in which electronic components such as the bus bar connection part 14, the mounted component 15, and a conductive member 17 are stored.

For example, the lower case 11 includes a bottom wall part 11a and a peripheral wall part 11b that protrudes from the peripheral part of the bottom wall part 11a toward one end side (upper side) in the height direction Z. The bottom wall part 11a and the peripheral wall part 11b are structures that partition the storage space part 11c described above serving as an interior space part of the housing 10. In the present embodiment, the bus bar connection part 14 is provided on one end side (right side) in the extending direction X than the center of the storage space part 11c in the extending direction X, and the mounted component 15 is provided on the other end side (left side) in the extending direction X than the center of the storage space part 11c in the extending direction X.

Then, the bus bar connection part 14 is electrically connected to the mounted component 15 via the conductive member 17 in the storage space part 11c. In the present embodiment, the lower case 11 is provided with ribs 11d that support the bus bar connection part 14, the mounted component 15, the conductive member 17, and the like, at one end side of the storage space part 11c in the height direction.

For example, the bus bar connection part 14 is formed by a stud bolt or the like. The bus bar connection part 14 protrudes from the conductive member 17 along the height direction Z, and is electrically connected to a bus bar 2 of the bus bar unit 4, by being fastened to the bus bar 2 via a nut or the like. For example, the mounted component 15 is formed by an electronic component such as a fuse, a relay, or a sensor through which power is supplied. For example, the mounted component 15 includes the conductor part 16 (live part) formed by a stud bolt or the like. For example, the mounted component 15 is electrically connected to the conductive member 17, by being fastened to the conductive member 17 via the conductor part 16, a nut, or the like. At least the conductor part 16 (live part) of the mounted component 15 is covered by the cover 20 in an openable and closable manner. For example, the conductive member 17 is formed by a terminal metal fitting that electrically connects between the bus bar connection part 14 and the mounted component 15, or the like.

For example, the upper case 12 includes a top wall part 12a and a peripheral wall part 12b that protrudes from the peripheral part of the top wall part 12a toward the other end side (lower side) in the height direction Z. The top wall part 12a and the peripheral wall part 12b are structures that partition the storage space part 11c of the housing 10 described above together with the lower case 11. In the present embodiment, the upper case 12 is provided with an opening part 12c for exposing the bus bar connection part 14 and the mounted component 15 stored in the storage space part 11c. For example, the opening part 12c is a through hole that penetrates through the top wall part 12a along the height direction. Moreover, the upper case 12 is provided with a vertical wall part 12d to which the bus bar unit 4 is engaged. The vertical wall part 12d protrudes from the peripheral part of the opening part 12c from which the bus bar connection part 14 is exposed in the top wall part 12a, toward one end side (upper side) in the height direction Z. For example, the vertical wall part 12d includes a pair of first vertical walls that support both ends of the bus bar unit 4 in the width direction Y, and a second vertical wall that supports the other end side (mounted component 15 side) of the bus bar unit 4 in the extending direction X.

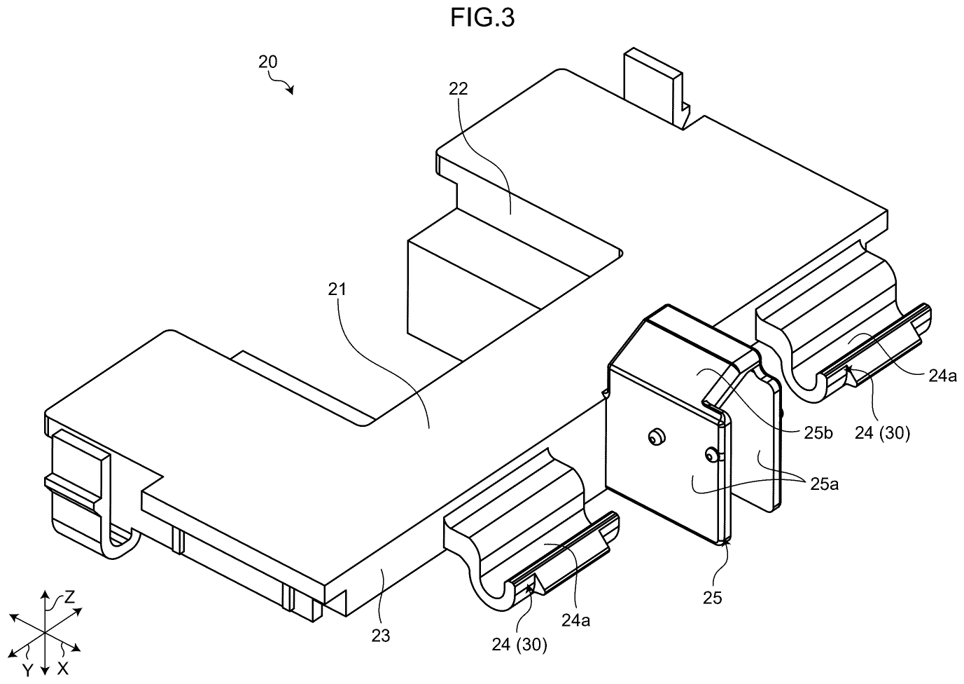

Moreover, for example, the upper case 12 includes a shaft part 12e with which an engagement part 24 (see FIG. 3) of the cover 20 is engaged (pivotally supported). The shaft part 12e forms the hinge 30 together with the engagement part 24 of the cover 20. For example, the shaft part 12e is provided at the center of the upper case 12 in the extending direction X, that is, between the opening part 12c from which the mounted component 15 is exposed and the opening part 12c from which the bus bar connection part 14 is exposed. The shaft part 12e extends along the width direction Y. In the present embodiment, a pair of the shaft parts 12e are provided in the upper case 12 along the width direction Y with an interval therebetween. The pair of shaft parts 12e support the engagement part 24 of the cover 20 in a rotatable manner about the rotation center extending along the width direction Y.

FIG. 3 is a perspective view of the cover 20 of the electrical junction box 1. As illustrated in FIG. 3, for example, the cover 20 includes an upper wall part 21, a pair of side wall parts 22 and 23, an engagement part 24, and an interference part 25. The upper wall part 21 covers the conductor part 16 (live part) of the mounted component 15 described above from one end side (upper side) in the height direction Z in an openable and closable manner. In the present embodiment, when viewed from the height direction Z, the upper wall part 21 is formed in a substantially U-shape that opens toward the other end side (side opposite to the bus bar unit 4) in the extending direction X. That is, the upper wall part 21 includes a first portion that extends along the width direction Y at one end side (bus bar unit 4 side) in the extending direction X, and a second portion that extends from both ends of the first portion in the width direction Y toward the side opposite to the bus bar unit 4 along the extending direction X.

The pair of side wall parts 22 and 23 cover the conductor part 16 (live part) of the mounted component 15 described above in an openable and closable manner from both sides in the width direction Y. The pair of side wall parts 22 and 23 protrude from the peripheral part of the upper wall part 21 toward the other end side (lower side) in the height direction Z. In the present embodiment, the pair of side wall parts 22 and 23 extend in a substantially U-shaped manner along the first portion and the second portion of the upper wall part 21 described above. The side wall part 22 forms the side wall at the inner peripheral side of the upper wall part 21, and the side wall part 23 forms the side wall at the outer peripheral side of the upper wall part 21.

The engagement part 24 is engaged to the shaft part 12e (see FIG. 4) of the upper case 12 described above. The engagement part 24 forms the hinge 30 together with the shaft part 12e of the upper case 12. For example, the engagement part 24 protrudes from the side wall part 23 at the outer peripheral side of the cover 20 described above in a claw shape. The tip end of the engagement part 24 is provided with a concave part 24a with which the shaft part 12e is engaged. The concave part 24a extends along the shaft part 12e in the width direction Y. In the present embodiment, a pair of the engagement parts 24 are provided corresponding to the pair of shaft parts 12e along the width direction Y with an interval therebetween. The pair of engagement parts 24 are engaged to (pivotally supported by) the pair of shaft parts 12e in a rotatable manner about the rotation center extending along the width direction Y.

While the cover 20 is located at the close position P1 (see FIG. 4), the interference part 25 allows the connection between the bus bar connection part 14 and the bus bar unit 4, and while the cover 20 is located at the open position P2 (see FIG. 5), the interference part 25 does not allow the connection between the bus bar connection part 14 and the bus bar unit 4. For example, the interference part 25 is provided between the pair of engagement parts 24 described above of the cover 20. For example, the interference part 25 includes a pair of protruding walls 25a that protrude from the side wall part 23 at the outer peripheral side of the cover 20 along the extending direction X, and a connection wall 25b that connects one ends (upper ends) of the pair of protruding walls 25a in the height direction Z. In the present embodiment, the pair of protruding walls 25a protrude toward one end side (bus bar unit 4 side) in the extending direction X than the engagement part 24. Moreover, the pair of protruding walls 25a protrude toward one end side (upper side) in the height direction Z than the upper wall part 21. For example, the connection wall 25b is formed in a substantially U-shape that is opened toward the other end side (lower side) in the height direction Z, and connects the pair of protruding walls 25a at one end side (upper side) in the height direction Z than the upper wall part 21.

FIG. 4 is a plan view of the electrical junction box 1, while the cover 20 is located at the close position P1. FIG. 5 is a plan view of the electrical junction box 1, while the cover 20 is located at the open position P2.

As illustrated in FIGS. 4 and 5, the bus bar unit 4 supplies power to the mounted component 15 via the bus bar connection part 14 described above. For example, the bus bar unit 4 includes the bus bar 2, and a bus bar case 3 that stores the bus bar 2. For example, the bus bar case 3 is formed in a substantially rectangular box shape using an insulating resin material or the like. The bus bar case 3 is provided with an opening part for exposing the bus bar 2. In the bus bar unit 4, the bus bar 2 and the bus bar connection part 14 can be connected (fastened) via the opening part of the bus bar case 3. Moreover, the bus bar 2 is provided with a through hole through which the bus bar connection part 14 penetrates along the height direction Z.

In the present embodiment, while the cover 20 is located at the close position P1 (see FIG. 4), the interference part 25 is located outside a connection area T of the bus bar connection part 14 and the bus bar unit 4, and while the cover 20 is located at the open position P2 (see FIG. 5), the interference part 25 intrudes into the inside of the connection area T. For example, while the bus bar connection part 14 and the bus bar unit 4 are connected, when viewed from the height direction Z, the connection area T is an area enclosed by the contour of the bus bar case 3. That is, the connection area T is an area where the bus bar unit mounted part and the bus bar case 3 in the housing 10 are overlapped along the height direction Z.

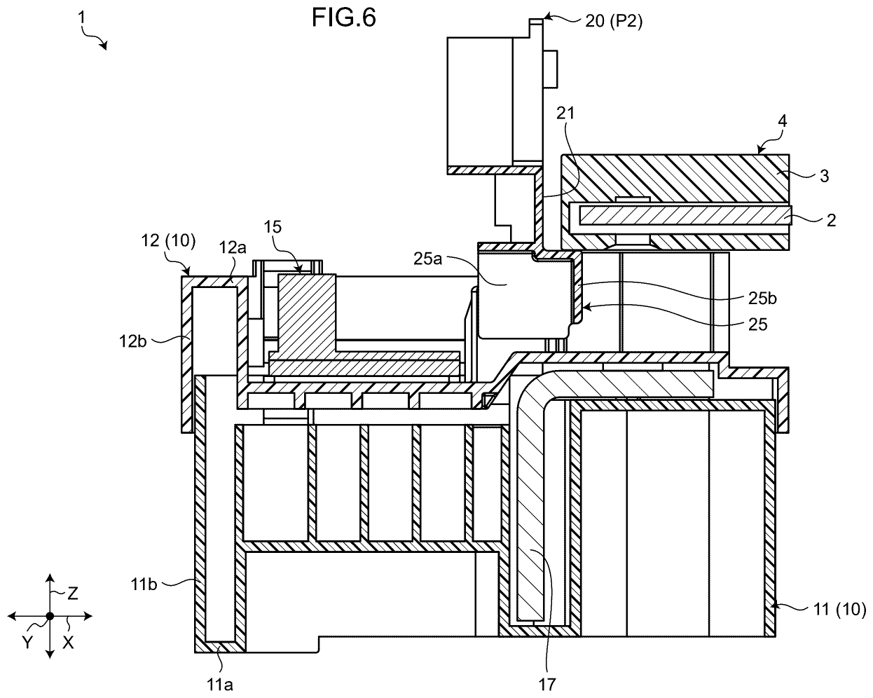

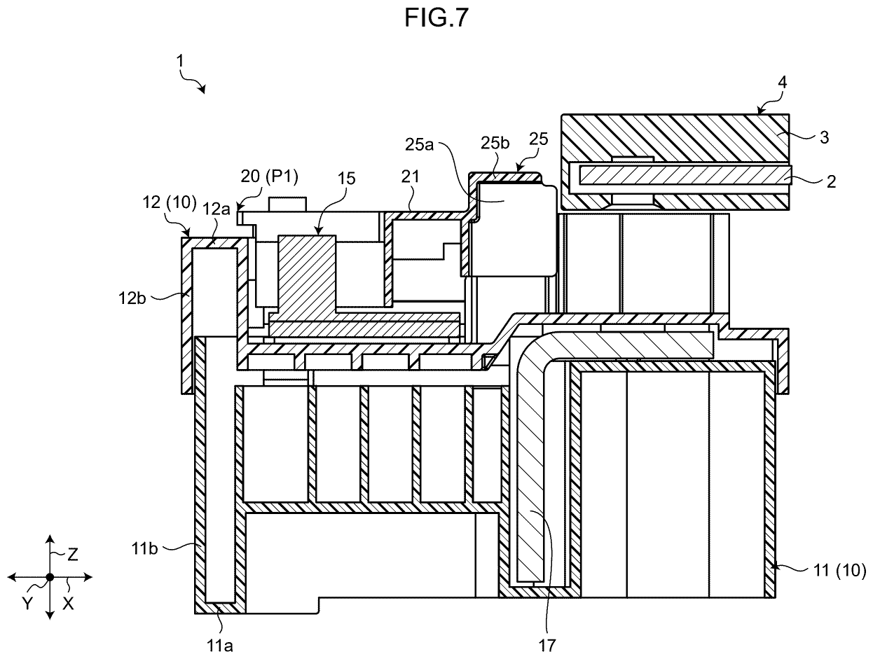

FIG. 6 is a sectional view of the electrical junction box 1, while the cover 20 is located at the open position P2. FIG. 7 is a sectional view of the electrical junction box 1, while the cover 20 is located at the close position P1 and before the bus bar unit 4 is assembled.

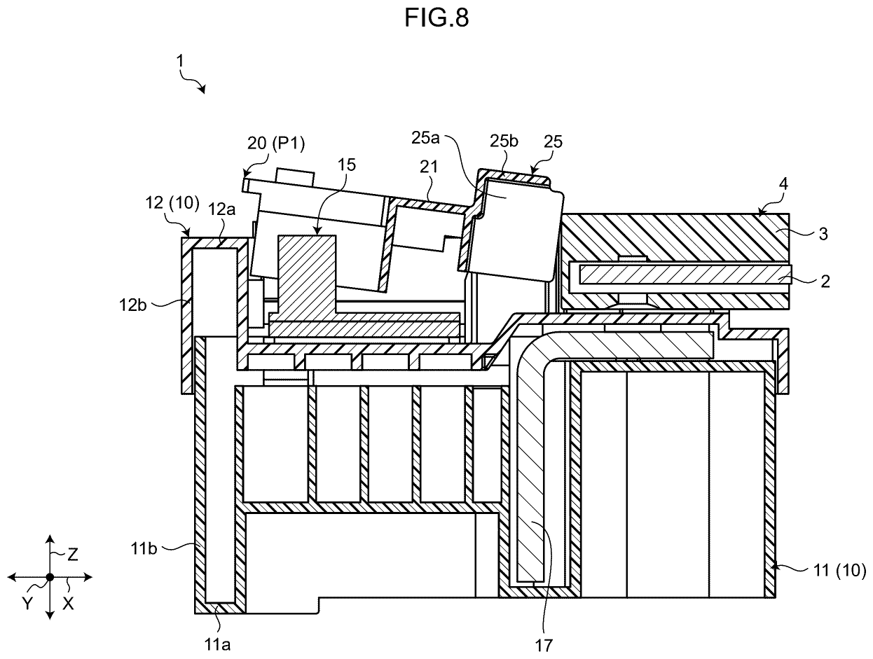

FIG. 8 is a sectional view of the electrical junction box 1, while the cover 20 is located at the close position P1 and after the bus bar unit 4 is assembled.

As illustrated in FIG. 6, in the present embodiment, while the cover 20 is located at the open position P2, the interference part 25 intrudes into the inside of the connection area T described above. Therefore, in the present embodiment, while the cover 20 is located at the open position P2, when the bus bar unit 4, that is, the bus bar 2 exposed from the opened part of the bus bar case 3 is to be connected to the bus bar connection part 14 (see FIG. 5), the interference part 25 and the bus bar case 3 interfere with each other along the height direction Z. Consequently, the connection between the bus bar connection part 14 and the bus bar unit 4 is not allowed.

On the other hand, as illustrated in FIG. 7, in the present embodiment, while the cover 20 is located at the close position P1, the interference part 25 is located outside the connection area T described above. In other words, while the cover 20 is located at the close position P1, the interference part 25 is shifted from the connection area T to the other end side in the axial direction X. Therefore, in the present embodiment, while the cover 20 is located at the close position P1, when the bus bar unit 4, that is, the bus bar 2 exposed from the opening part of the bus bar case 3 is to be connected to the bus bar connection part 14 (see FIG. 4), the interference part 25 and the bus bar case 3 do not interfere with each other along the height direction Z. Consequently, the connection between the bus bar connection part 14 and the bus bar unit 4 is allowed.

Moreover, as illustrated in FIG. 8, in the present embodiment, while the cover 20 is located at the close position P1, when the cover 20 is to be rotated to the open position P2, the interference part 25 and the bus bar case 3 interfere (abut) with each other, and the cover 20 remains at the close position P1. Consequently, while the bus bar unit 4 and the mounted component 15 are electrically connected, the cover 20 is prevented from moving to the open position P2, and the conductor part (live part) of the mounted component 15 is prevented from being exposed.

As described above, in the electrical junction box 1 of the present embodiment, the cover 20 includes the interference part 25 that allows the connection between the bus bar connection part 14 and the bus bar unit 4 while the cover 20 is located at the close position P1, and that does not allow the connection between the bus bar connection part 14 and the bus bar unit 4 while the cover 20 is located at the open position P2. With this configuration, for example, in the electrical junction box 1, by the interference part 25, the connection between the bus bar connection part 14 and the bus bar unit 4 is allowed while the cover 20 is located at the close position P1, and the connection between the bus bar connection part 14 and the bus bar unit 4 is not allowed while the cover 20 is located at the open position P2. As a result, with the electrical junction box 1, the mounted component 15 can be properly replaced, and the mounted component 15 can be replaced more safely.

Moreover, in the electrical junction box 1 of the present embodiment, the interference part 25 is located outside the connection area T of the bus bar connection part 14 and the bus bar unit 4 while the cover 20 is located at the close position P1, and the interference part 25 intrudes into the inside of the connection area T while the cover 20 is located at the open position P2. With this configuration, for example, in the electrical junction box 1, in addition to allowing the connection between the bus bar connection part 14 and the bus bar unit 4 while the cover 20 is located at the close position P1, and not allowing the connection between the bus bar connection part 14 and the bus bar unit 4 while the cover 20 is located at the open position P2, the cover 20 can be prevented from moving to the open position P2 from the close position P1 while the bus bar unit 4 and the mounted component 15 are electrically connected by the interference part 25.

Moreover, in the electrical junction box 1 of the present embodiment, the bus bar unit 4 includes the bus bar 2 and the bus bar case 3 that stores the bus bar 2. Hence, while the bus bar connection part 14 and the bus bar unit 4 are connected, the connection area T is an area enclosed by the contour of the bus bar case 3. With this configuration, for example, in the electrical junction box 1, the connection area T of the bus bar connection part 14 and the bus bar unit 4 can be formed relatively easily by an area enclosed by the contour of the bus bar case 3, in other words, by an area where the bus bar unit mounted part and the bus bar case 3 in the housing 10 are overlapped along the height direction Z in the housing 10.

In the present embodiment, an example in which the bus bar unit 4 includes the bus bar 2 and the bus bar case 3 that stores the bus bar 2 is described. However, it is not limited thereto, and for example, the bus bar unit 4 may be formed by the bus bar 2 alone. Moreover, in the present embodiment, an example in which the housing 10 includes the lower case 11 and the upper case 12 is described. However, it is not limited thereto, and for example, the housing 10 may be formed by the lower case 11 alone. Furthermore, in the present embodiment, an example in which the cover 20 at least covers the conductor part 16 of the mounted component 15 in an openable and closable manner is described. However, it is not limited thereto, and for example, the cover 20 may cover the entire mounted component 15 in an openable and closable manner.

While the embodiment of the present invention has been described above, the above embodiment is merely an example, and is not intended to limit the scope of the invention. The above embodiment may be implemented in various other forms, and various omissions, substitutions, combinations, and changes may be made without departing from the gist of the invention. Moreover, specifications (structure, type, direction, format, size, length, width, thickness, height, number, arrangement, position, material, and the like) of each configuration, shape, and the like can be appropriately changed and implemented.

With the electrical junction box according to the present invention, for example, the interference part of the cover allows the connection between the bus bar connection part and the bus bar unit while the cover is located at the close position, and does not allow the connection between the bus bar connection part and the bus bar unit while the cover is located at the open position. As a result, with the electrical junction box, the mounted component can be properly replaced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electrical junction box comprising:
a housing that includes a bus bar connection part to which a bus bar unit is connected, and a mounted component to which power is supplied from the bus bar unit via the bus bar connection part;
a cover that covers at least a conductor part of the mounted component in an openable and closable manner; and
a hinge that connects the cover to the housing in a rotatable manner between a close position and an open position, wherein
the cover includes an interference part that allows a connection between the bus bar connection part and the bus bar unit while the cover is located at the close position, and that does not allow a connection between the bus bar connection part and the bus bar unit while the cover is located at the open position.

2. The electrical junction box according to claim 1, wherein
the interference part is located outside a connection area of the bus bar connection part and the bus bar unit while the cover is located at the close position, and the interference part intrudes into an inside of the connection area while the cover is located at the open position (P2).

3. The electrical junction box according to claim 2, wherein
the bus bar unit includes a bus bar and a bus bar case that stores the bus bar, and
the connection area is an area enclosed by a contour of the bus bar case while the bus bar connection part and the bus bar unit are connected.
